(19) United States
(12) Patent Application Publication
(10) Pub. No.: US 2009/0279313 A1
(43) Pub. Date: Nov. 12, 2009

(54) OPTICAL COMPONENT, LIGHTING DEVICE FOR DISPLAY DEVICE, AND DISPLAY DEVICE

(75) Inventor: Daisuke Teragawa, Tsu-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/306,744

(22) PCT Filed: Feb. 21, 2007
(86) PCT No.: PCT/JP2007/053207

§ 371 Date: Dec. 29, 2008

(30) Foreign Application Priority Data
Jul. 12, 2006 (JP) 2006-191475

(51) Int. Cl. F21V 11/00; B32B 3/10

(52) U.S. Cl. 362/355; 428/188; 428/188

(57) ABSTRACT

An optical component is used in a lighting device for a display device. The optical component includes a translucent plate-shaped body. The plate-shaped body has a plurality of air holes arranged to distribute air in the plate-thickness direction of the plate-shaped body, and the air holes providing a light scattering structure arranged to scatter light.

### BACKGROUND OF THE INVENTION

1. Field of the Invention

The present invention relates to an optical component, a lighting device for a display device, and a display device. More particularly, the present invention relates to technology for reducing the occurrence of warpage caused by the difference in dry conditions (moisture absorbing conditions) on each surface, and preventing the deterioration of display quality due to such warpage.

2. Description of the Related Art

FIG. 8 shows a cross sectional view illustrating a conventional backlight 20Z employed in a liquid crystal display device 10Z. The backlight 20Z is arranged on a rear surface of the liquid crystal panel 30Z in the liquid crystal display device 10Z. In the backlight 20Z, lamps 100Z are aligned in a lamp housing 200Z, and a diffuser plate 400Z made of resin is arranged so as to face the lamps 100Z and cover the lamp housing 200Z. An optical sheet 500Z, such as a diffuser sheet, is arranged on the diffuser plate 400Z.

In general, a resin swells when it absorbs moisture, and shrinks when the moisture is evaporated and dried. In addition, a resin also swells and shrinks in response to heat, however, swelling and shrinking rates due to heat are greater than by absorbing moisture and by being dried.

When the backlight 20Z is placed in a high-humidity environment, a resin-made member, such as the diffuser plate 400Z, swells by absorbing moisture. When the backlight 20Z is turned on when moisture is absorbed in the resin-made members, moisture evaporates from the diffuser plate 400Z due to heat generated from the lamps 100Z. This moment, a first main surface 420Z (see FIG. 9) of the diffuser plate 400Z on the side of the lamps 100Z is closer to the lamps 100Z and heated directly. Therefore, on the first main surface 420Z, moisture evaporates more easily than on a second surface 410Z (see FIG. 9), that is opposite to the first main surface 420Z in the diffuser plate 400Z. Moreover, since optical sheets 500Z are put on the second main surface 410Z, moisture hardly evaporates from the side of the second main surface 410Z, in other words, moisture evaporates more easily on the first main surface 420Z on the side of the lamps 100Z. Consequently, on the first main surface 420Z on the side of the lamps 100Z, the amount of absorbed moisture decreases, in short, the dry level increases. Due to such a difference in the dry level, the first main surface 420Z in the side of the lamps 100Z shrinks more, and therefore, as illustrated in FIG. 9, a warpage rising toward the liquid crystal panel 30Z occurs in the diffuser plate 400Z.

Such warpage of the diffuser plate 400Z presses the liquid crystal pane 130Z through the optical sheets 500Z and upsets the required uniformity in the thickness of a liquid crystal layer. As a result, the display quality of the liquid crystal panel 30Z degrades. For the purpose of solving such problem, the conventional art, for example, Japanese Unexamined Patent Publication No. 2004-53749 and Japanese Unexamined Patent Publication No. 2005-202315 can be suggested.

Japanese Unexamined Patent Publication No. 2004-53749 discloses a technology in which the warpage of a diffuser plate is prevented by providing ventilation through a passage hole in order to suppress a temperature increase inside of the backlight device, however, such structure may not achieve a sufficient diffusing effect. And also, Japanese Unexamined Patent Publication No. 2005-202315 discloses a technology in which the warpage of a diffuser plate is suppressed by a warpage control member. However, the warpage control member may increase the number of components, thereby enlarging the size of the device.

### SUMMARY OF THE INVENTION

Preferred embodiments of the present invention provide an optical component capable of minimizing an occurrence of warpage as mentioned above without enlarging the size of a device, while achieving a desired light scattering effect. Preferred embodiments of the present invention also provide a lighting device for a display device, and a display device which can improve the display quality with the above optical component.

According to one preferred embodiment of the present invention, an optical component used in a lighting device for a display device includes a plate-shaped body arranged to transmit light, a plurality of air passage portions provided in the plate-shaped body to allow air to pass in a thickness direction of the plate-shaped body, and the air passage portions have a light scattering structure arranged to scatter light.

According to the above-mentioned structure, the air passage is secured by the air passage portions, and thus, the heated air is distributed efficiently from the side of, for example, a main surface (the second main surface) on which light sources for a display device are arranged to the side of an opposite main surface (the first main surface). This enables air convection to occur faster than heat conduction through the plate-shaped body, thereby equalizing the heat inside of the present plate-shaped body. As a result, the difference of moisture evaporation amount, and therefore, the difference of dry level between the first main surface and the second main surface of the plate-shaped body hardly ever occurs, thereby efficiently preventing or controlling the occurrence of warpage. In addition, since the air passage portions includes the light scattering structure, the optical component can preferably be employed as a light scattering plate of a lighting device for a display device. In short, according to a preferred embodiment of the present invention, there can be provided an optical component including the light scattering function which can prevent the occurrence of warpage even when receiving heat, and which does not enlarge the size of the device since the number of components does not increase.

The air passage portions can be provided as passage holes that extend through the plate-shaped body in a plate-thickness direction, and at the same time, as a light scattering structure in which the hole axis direction of the air hole changes in a plurality of phases inside of the plate-shaped body. As mentioned above, when the hole axis direction changes in a plurality of phases inside of the plate-shaped body, refraction of light occurs at a changing point, thereby delivering the function of light scattering. Consequently, the light scattering function can be enhanced. In order to change the hole axis direction, a structure can be preferably employed in which a hole is arranged in a zigzag manner in the plate-thickness direction extending there through, or in which, for example, microscopical holes are connected randomly in the plate-thickness direction.

The plate-shaped body may be made of, for example, any one of a polycarbonate resin, a polystyrene resin, an olefin resin, and an acrylic resin. These resins have an extremely low hygroscopic nature, and thus, the difference in dry level between the first main surface side and the second main surface side in the plate-shaped body hardly occurs. This is why the warpage caused by heat will not occur.

The plate-shaped body can be made of, for example, a resin, in which any one of a polycarbonate resin, a polystyrene resin and an olefin resin are mixed with an acrylic resin. The plate-shaped body is made of, for example, a resin in which any one of a polycarbonate resin, a polystyrene resin, and an olefin resin all having a low hygroscopic nature are mixed with an acrylic resin having a relatively high hygroscopic nature, so that the hygroscopic nature of the plate-shaped body decreases. Moreover, this makes it difficult for a difference of a dry level between the first main surface and the second main surface to occur, thereby minimizing the warpage caused by heat. In addition, the plate-shaped body can be made of, for example, a material in which a translucent inorganic material is mixed with the translucent resin.

The plate-shaped body can be made of, for example, a flexible foam. The flexible foam is, for example, a porous resin foam. Since the hole provides the air hole that allows an airflow directed between the first main surface and the second main surface, the problem in which only one side surface dries hardly ever occurs. This enables the diffuser plate itself to function as a structure of the plate-shaped body without using diffusing material. Additionally, flexible foam is inexpensive and reduces the weight of a display device, thereby contributing to the cost reduction.

The plate-shaped body can be provided by a sheet material woven with fibers. More particularly, a sheet material is preferably provided with a plurality of sheets woven with a translucent fiber and overlapped one on top of another. In this case, the gap between fibers forms an air hole, allowing the air flow directed between the first main surface and the second main surface. Consequently, the problem in which only one side surface dries hardly ever occurs, and therefore, the diffuser plate can deliver provide a structure of the plate-shaped body itself without using a diffusing material.

The plate-shaped body may include a sheet that includes a plurality of spherical resin particles strung together like beads. In this case, the gap between spherical resins beaded together forms an air hole that allows air flow directed between the first main surface and the second main surface. Consequently, the problem in which only one side surface dries hardly ever occurs, and therefore, the diffuser plate can provide a structure of the plate-shaped body itself without using a diffusing material.

The plate-shaped body can be provided by a laminated sheet material in which a plurality of thin sheets having a plurality of pores are laminated. More particularly, a sheet material is preferably provided with a plurality of thin resin sheets having a high density of random holes that are overlapped one on top of another. In this case, the pores between the laminated sheets connect in the plate-thickness direction and provide an air hole, allowing the air flow to be guided between the first main surface and the second main surface. Consequently, the problem in which only one side surface dries hardly ever occurs, and therefore, the diffuser plate can provide a structure of the plate-shaped body itself without using diffusing material.

Next, another preferred embodiment of a lighting device for a display device according to the present invention includes the above-mentioned optical component according to a preferred embodiment of the present invention, and a light source positioned so as to enable light irradiation relative to one main surface of the optical component. With such a structure, there can be provided a lighting device for a display device which contributes to improve the display quality of the display device by delivering the above-mentioned effect.

In addition, the light source is preferably any one of a cold cathode fluorescent lamp (CCFL), a hot cathode fluorescent lamp (HCFL), an external electrode fluorescent lamp (EEFL), a light emitting diode (LED), or a xenon fluorescent lamp. Such light sources generate high heat, and the above-mentioned warpage preventing effect can therefore be preferably achieved.

Also, the optical component functions as a diffuser plate in the present lighting device for a display device. In other words, since the optical component defines a light scattering structure, the lighting device for a display device can include the optical component as a diffuser plate.

Additionally, for the purpose of solving the above-mentioned problems, a lighting device for a display device according to a preferred embodiment of the present invention includes the above-mentioned optical component, and a light controlling member arranged to control the permeability of light that has been emitted from the light source and gone through the optical component. With such structure, the above-mentioned warpage preventing effect can prevent the light controlling member from being pressed by the warpage of the optical component. Consequently, a display device in which deterioration of the display quality based on such pressing is improved can be provided. In addition, the light controlling member is preferably a liquid crystal panel, so that a liquid crystal display device having an excellent display quality can be provided.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is an exploded perspective view explaining a display device according to one preferred embodiment of the present invention.

FIG. 2 is a perspective view showing the entire configuration of a diffuser plate employed in the display device in FIG. 1.

FIG. 3 is a plan view showing the plan configuration of a diffuser plate employed in the display device in FIG. 1.

FIG. 4 is a cross sectional view showing the main configuration of a diffuser plate employed in the display device in FIG. 1.

FIG. 5 is a perspective view showing the entire configuration of one diffuser plate according to a preferred embodiment of the present invention.

FIG. 6 is a perspective view showing the entire configuration of another diffuser plate according to a preferred embodiment of the present invention.

FIG. 7 is a perspective view showing the entire configuration of another version of a diffuser plate according to a preferred embodiment of the present invention.

FIG. 8 is a cross-sectional pattern diagram explaining a backlight for a conventional liquid crystal display device.

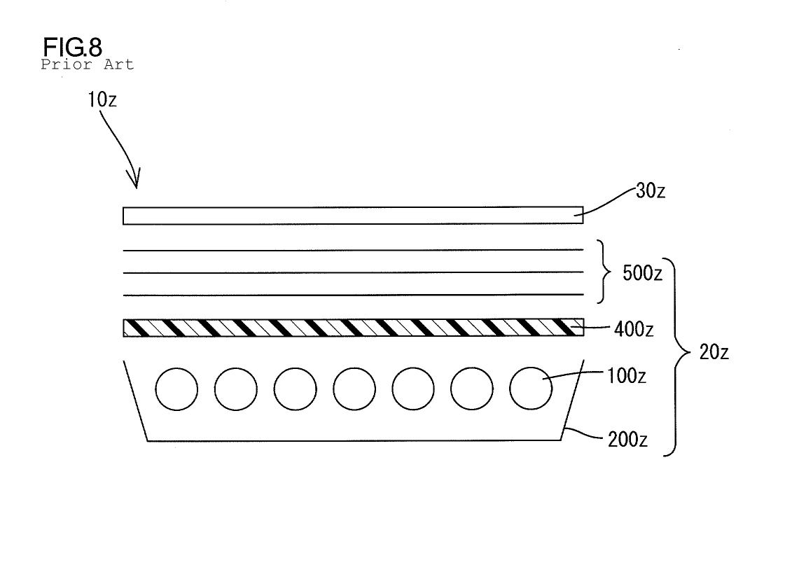

FIG. 9 is a cross-sectional pattern diagram explaining a problem of a backlight for a liquid crystal display device in FIG. 8.

### DETAILED DESCRIPTION OF THE PREFERRED EMBODIMENTS

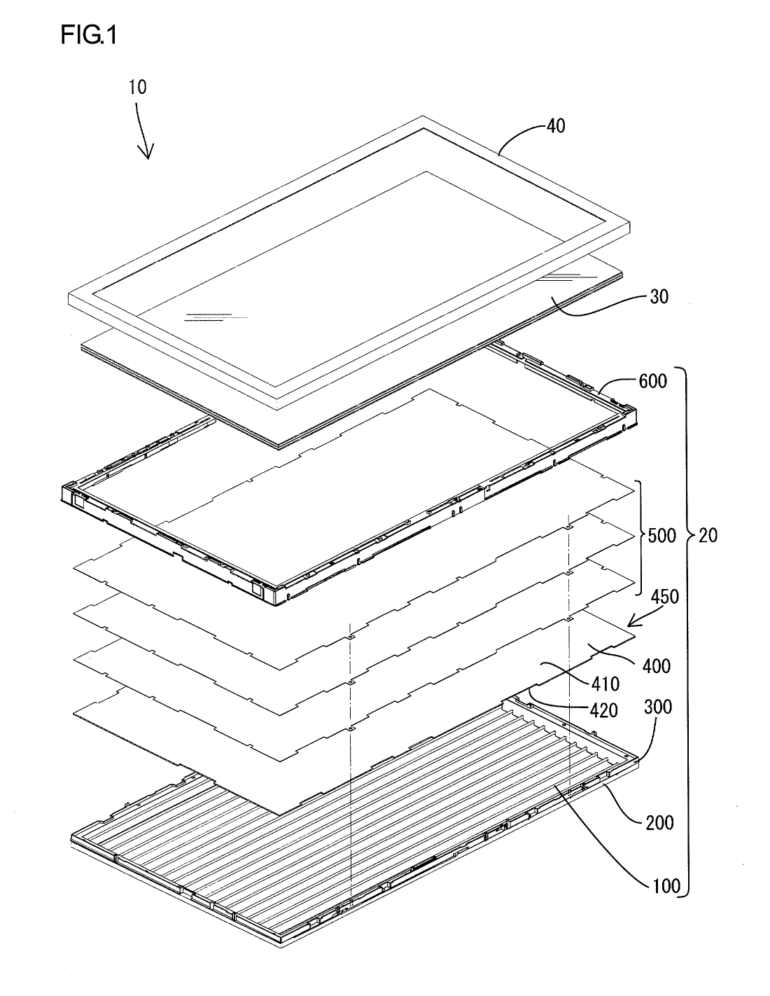

In what follows, preferred embodiments of the present invention are explained with reference to the accompanying figures. FIG. 1 is an exploded perspective view explaining a display device 10 according to one preferred embodiment of the present invention. Display device 10 is, what is called, a liquid crystal display device, including a lighting device for a display device (hereinafter referred to simply as “lighting device”) 20, a liquid crystal panel 30, and a display device frame 40. In addition, the lighting device 20 includes an optical component 450 defined by a lamp 100, a lamp house 200, a reflective sheet (not shown), a lamp holder 300, and a resin-made diffuser plate 400, an optical sheet 500, and a lighting device frame 600. Here, a cold cathode fluorescent lamp (CCFL), for example, is illustrated in the figure as the lamp 100.

Firstly, the lighting device 20 is described. The lamp house 200 has a vessel-shaped portion, with the reflective sheet (not shown) spread in the bottom thereof, and further a plurality of lamps 100 aligned thereon. Additionally, the number of the lamps 100 is not limited to eighteen as shown in the figure, but can be any desirable number. The lamp holder 300 has a frame-shaped inside portion of the lamp house 200 that is housed inside of the above-mentioned vessel-shaped portion, and the present inside portion of the lamp house supports the lamps 100. The lamp holder 300 has a collar portion protruding from the inside of the lamp house to the outside, and the diffuser plate 400 is put on the collar portion. Additionally, the lamp holder 300 and the reflective sheet are, for example, white, and therefore reflect the light emitted from lamps 100 to contribute to the brightness improvement of the emitted light (or illuminating light).

The diffuser plate 400 defined by the optical component 450 is preferably made of a material having translucent nature and extremely low hygroscopic nature. As a specific material, in addition to a polycarbonate resin, a polystyrene resin, and a polyolefin resin, acrylic resins, such as a polyethylene terephthalate and a polymethylmethacrylate, and synthetic resins such as a methacrylic styrenic resin, a styrene/methacrylate copolymer, a polyethylene, and a polystyrene, can be used, and also an inorganic material, such as glass, may be employed. Furthermore, a resin in which any one of a polycarbonate resin, a polystyrene resin, and an olefin resin are mixed with an acrylic resin may be employed, for example.

The diffuser plate 400 has the first main surface 410 and the second main surface 420 being mutually parallel or substantially parallel, and the distance between both the main surfaces 410 and 420, in other words, the thickness of the diffuser plate 400 preferably is, for example, about 2 mm. The diffuser plate 400 is arranged to allow the light from the lamps 100 to be irradiated onto the second main surface 420, and moreover, so as to cover the vessel-shaped portion of the lamp house 200 opposing the lamps 100. Here, the lamps 100 are arranged in the side of the second main surface 420 of the diffuser plate 400, and, from the planar view of the first main surface 410, overlap with the diffuser plate 400. The diffuser plate 400 is described later in detail. The diffuser plate 400 plays a role of scattering light emitted from the lamps 100, and at the same time, also supporting the optical sheet 500. In short, the optical sheet 500 is disposed on the first main surface 410 of the diffuser plate 400.

The optical sheet 500 preferably includes one or a plurality of various optical sheets, such as, for example, a diffuser sheet, a prism sheet, a lens sheet, and a DBEF-D (Dual Brightness Enhancement Film-Diffuse). In addition, the number of various optical sheets forming the optical sheet 500 is not limited to three as shown in the FIG. 1. Also, a plurality of the same kind of optical sheets (for example, a diffuser sheet) may be included.

Then, the lighting device frame 600 is placed from the side of the optical sheet 500 and fixed to the lamp house 200 with, for example, a screw (not shown). This supports the diffuser plate 400 and the optical sheet 500 in the lighting device 20.

The display device 10 is arranged with the liquid crystal panel 30 combined with the lighting device 20. In other words, the liquid crystal panel 30 is arranged on the lighting device frame 600 to oppose to the optical sheet 500 (and thus, the liquid crystal panel 30 is arranged in the side of the first main surface 410 of the diffuser plate 400). A panel supporting member for supporting and positioning the liquid crystal panel 30 is formed in the lighting device frame 600 by a process of cutting and raising. The display device frame 40 is then placed from the side of the liquid crystal panel 30 and fixed to the lighting device frame 600 with, for example, a screw (not shown). This supports the liquid crystal panel 30 in the display device 10.

In the display device 10, the light emitted from the lamp 100 is then irradiated onto the liquid crystal panel 30 through the diffuser plate 400 and the optical sheet 500, and the light strength (gray level) thereof is then controlled or colored by each pixel (or each cell) of the liquid crystal panel 30. In short, the liquid crystal panel 30 controls the light, that has been emitted from the lamps 100 and passed through the diffuser plate 400 and the optical sheet 500, such that its light strength and color produce a display light. This is why the liquid crystal panel 30 can be called “a light controlling member”.

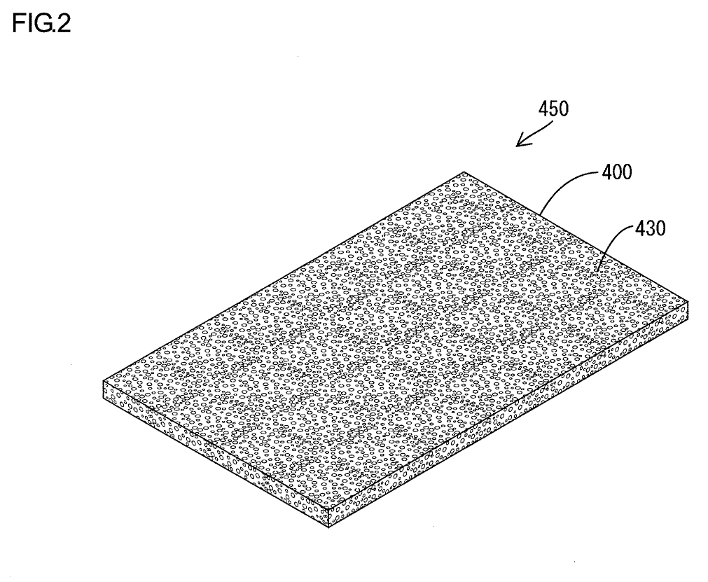

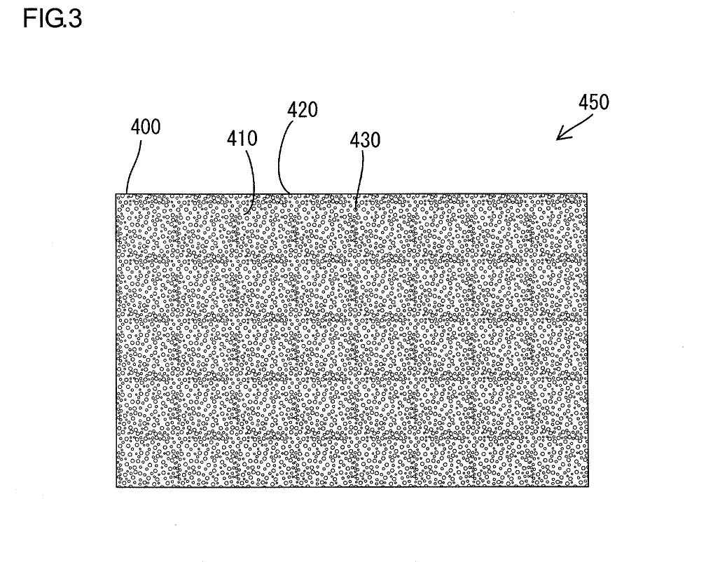

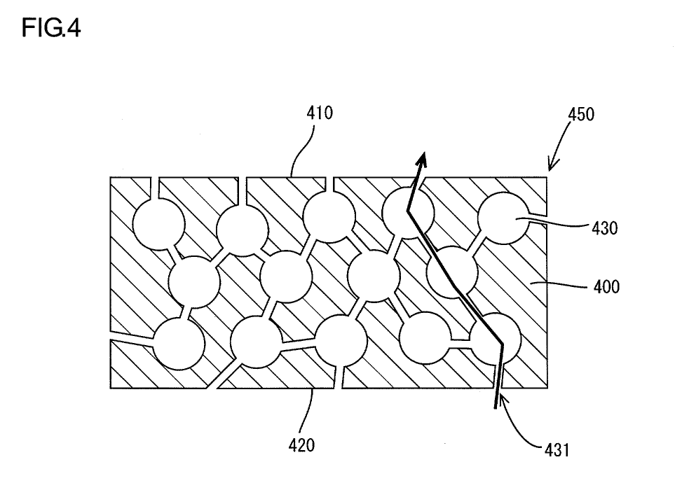

Next, the detailed structure of the diffuser plate 400 included in the lighting device 20 in the display device 10 is explained with reference to FIGS. 2 to 4. FIG. 2 is a perspective view of the diffuser plate 400, FIG. 3 is a plan view of the diffuser plate 400, and FIG. 4 is an enlarged cross sectional view of the diffuser plate 400. The diffuser plate 400 providing the optical component 450 of the present preferred embodiment is made of, for example, a flexible foam and internally contains a plurality of random holes 430. With the present holes 430 connected each other, air and moisture can pass through the diffuser plate 400 in the plate-thickness direction. More specifically, as shown in the cross sectional view of FIG. 4, air is distributed from the side of the second main surface 420 to the side of the first main surface 410 along the arrow direction, and the present hole 430 functions as a passage hole.

On the other hand, the above-mentioned hole 430 also has a function in scattering light. More particularly, as shown by the arrow in FIG. 4, the hole axis direction is arranged in a zigzag manner inside of the present diffuser plate 400, and such zigzag structure 431 enables light to be diffused. In short, each of the holes 430 is not connected linearly but connected in a zigzag manner from the side of the second main surface 420 to the side of the first main surface 410, such that light refraction occurs randomly due to the difference of refractive index between a random hole wall (made of, for example, resin) providing a zigzag structure and the air inside of the hole. This preferably scatters the light going through the present diffuser plate 400.

In addition, a flexible foam is preferably a plastic of low density (in the present preferred embodiment, the density is around 50%, for example) made by cubical expansion of a thermoplastic resin or a thermosetting resin using any desired method. As a result of the expansion, the inside thereof forms a cell structure, namely a foam structure, which is like a small beehive or an agglutinate of hollow spheres (holes 430). A method for preparing the present foam (holes 430) can use any known arts, however, for example, the following may be employed: 1) a method for mechanically beating in a resin molding process, 2) a physical method for mixing a gas or a liquid of low boiling point into a resin to be molded, 3) a method for containing a bloating agent that discharges a gas into a resin by heat, and 4) a chemical process for combining a foaming radical with a high molecule. In any one of the above methods, the resin goes through liquid state or plasticization state at one point for foam formation. In addition, as a molding method, such as slab molding, mold forming, laminate molding, and cast molding can be employed.

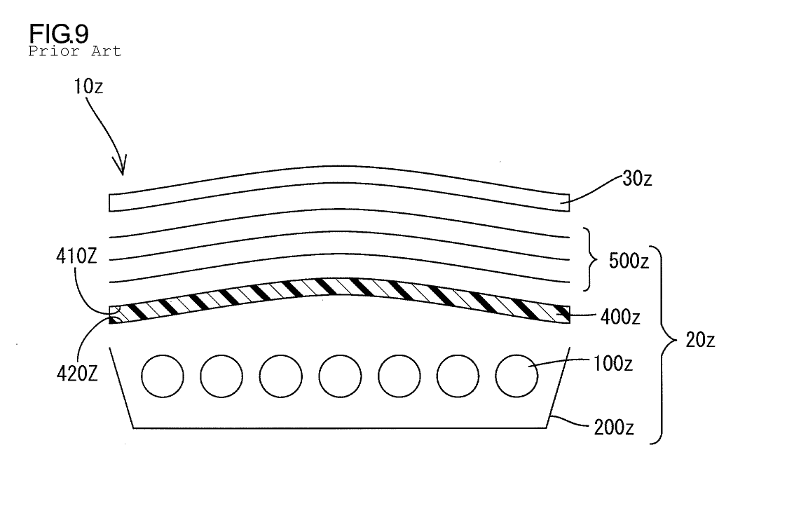

According to such diffuser plate 400, the air holes 430 secure the air distribution in the plate-thickness direction, and heated air is therefore distributed efficiently from the side of the second main surface 420 where the light sources 100 are arranged to the opposite side of the first main surface 410. Consequently, air convection will occur faster than heat conduction without using the holes 430 but using the material itself of the diffuser plate 400 as a media, thereby providing a uniform amount of heat inside of the member of the present diffuser plate 400. As a result, the difference of moisture evaporation amount, and therefore, a difference of dry levels between the first main surface 410 and the second main surface 420 of the diffuser plate 400 hardly ever occurs, thereby preventing or controlling efficiently the occurrence of warpage as shown in FIG. 9. In addition, since the air holes 430 define the light scattering structure 431, the present diffuser plate 400 can be preferably employed as a light scattering plate of the lighting device 20.

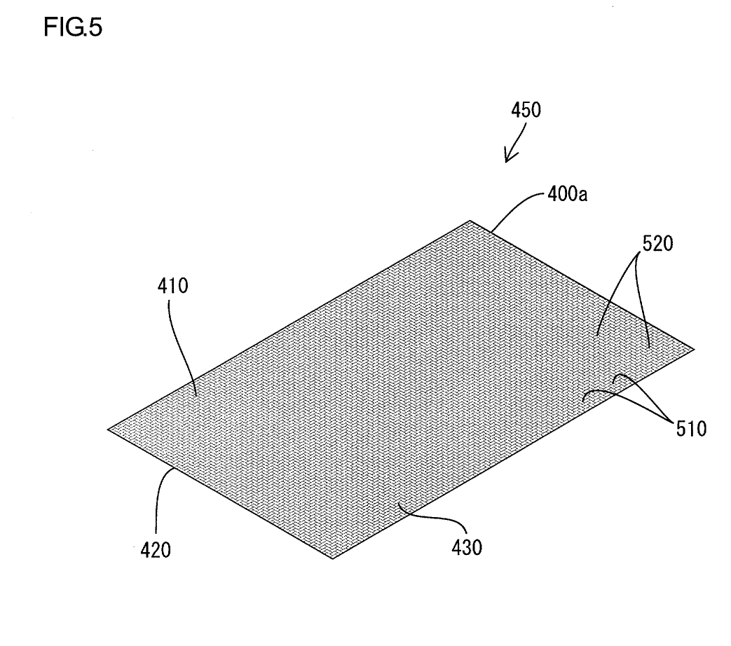

Next, versions of the diffuser plate 400 according to preferred embodiments of the present invention are explained. A diffuser plate 400a shown in FIG. 5 preferably includes a sheet material woven with fibers 510 and 520. More particularly, it is composed of a plurality of sheet materials woven with translucent fibers 510 (warp thread) and 520 (weft thread), and overlapped on top of one another.

In this case, the gap between the fibers 510 and 520 provides the air hole 430, which allows air flow directed between the first main surface 410 and the second main surface 420. Consequently, in the diffuser plate 400a, the problem in which only the side of the second main surface 420 where the light sources 100 are arranged dries hardly ever occurs, and it is possible to efficiently prevent or minimize the occurrence of warpage as shown in FIG. 9.

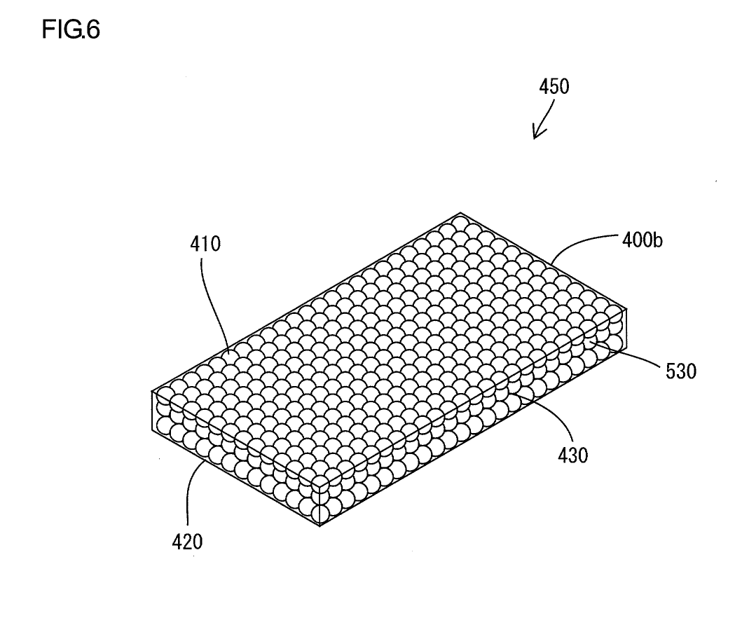

A diffuser plate 400b shown in FIG. 6 is defined by a sheet material having a plurality of spherical resins (resin balls) beaded together. More particularly, an adhesive is applied onto each of the spherical resins 530 to adhere each the spherical resin 530 on the same plane surface in the surface direction, such that a sheet composed of the present spherical resins 530 is provided. A plurality of the present sheets are overlapped on top of one another to provide the diffuser plate 400b. Additionally, the spherical diameter of the spherical resin 530 preferably is around 40 μm, or at the top, around 100 μm, however, the spherical diameter of the spherical resin 530 can be increased or decreased according to the screen size and the pixel number.

In this case, the gap between the spherical resins 530 beaded together forms the air hole 430, allowing the air flow guiding between the first main surface 410 and the second main surface 420. Consequently, in the diffuser plate 400b, the defect in that only the side of the second main surface 420 where the light sources 100 are arranged dries hardly occurs, and it is possible to efficiently prevent or suppress the occurrence of warpage as shown in FIG. 9.

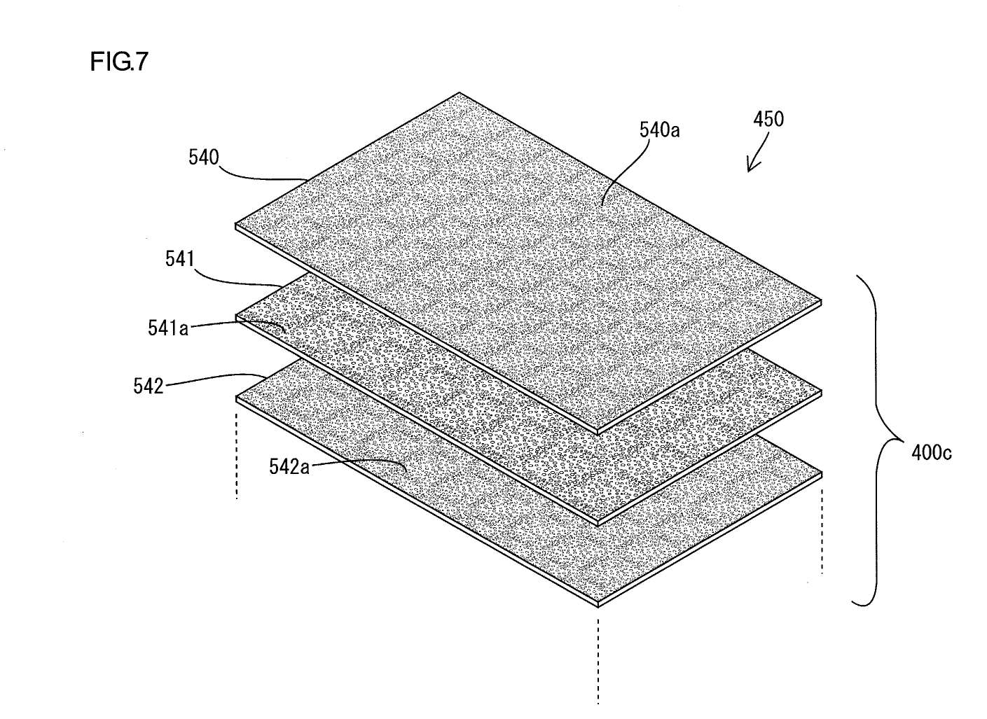

And also, a diffuser plate 400c shown in FIG. 7 is defined by a laminated sheet material, in which a plurality of thin sheets 540, 541, and 542 having a plurality of pores 540a, 541a, and 542a are laminated. More particularly, the pores 540a, 541a, and 542a open at random positions in a high density. Overlapping each of the sheets 540, 541, and 542 one on top of another provides an air hole 430, with the present pores 540a, 541a, and 542a laminated in a zigzag manner.

In this case, the air hole 430 provided by the pores 540a, 541a, and 542a allows the air flow guiding between the first main surface 410 and the second main surface 420. Consequently, in the diffuser plate 400c, the problem in which only the side of the second main surface 420 where the light sources 100 are arranged dries hardly ever occurs, and it is possible to efficiently prevent or suppress the occurrence of warpage as shown in FIG. 9.

The above description is only an example of preferred embodiments of the present invention, and various modifications and applications are possible. For example, as a light source for the lighting device 20, and instead of the illustrated lamps 100, such as a light emitting diode (LED), a hot cathode fluorescent lamp (HCFL), an external electrode fluorescent lamp (EEFL), and a xenon fluorescent lamp can be employed. In addition, preferred embodiments of the present invention can be applied not only to the above-mentioned downlight lighting device having the lamps 100 arranged immediately beneath the diffuser plate 400, but also to an edge light type lighting device. Moreover, the present invention can be applied not only to the above-mentioned diffuser plate 400, but also to various optical components (not limited to resin-made components) which may possibly generate warpage due to the difference in the dry condition (moisture absorbing condition) of surfaces. Additionally, an optical component made of a resin may provide advantages, such as inexpensiveness, good workability, lightness, and high light permeability, based on its resin property.

Moreover, the display device 10 can be provided with a non-spontaneous light emission type display panel, other than the liquid crystal panel 30, as a “light controlling member” combined with the lighting device 20. Here, when a member capable of controlling such as light strength (gray level) and color of the light (illuminating light) emitted from the lighting device 20 is regarded as, for example, a “light controlling member”, an advertising display with a backlight placed in such as stations, other than a display panel such as liquid crystal panel 30, can be regarded as a “light controlling member”. Here, the above-mentioned advertising display with a backlight is regarded as a “display device”, and at the same time, as a “lighting device for display devices”. Moreover, the lighting device 20 can be applied to, such as, an overhead projector (OHP) used in such as presentations, an X-ray film viewer for illuminating an X-ray film from the back, and a backlight box used in such as technical drawings.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-13. (canceled)

14. An optical component used in a lighting device for a display device, comprising:
a plate-like body capable of light transmission, wherein:
a plurality of air passage portions are formed in said plate-like body so as to allow air to pass in a thickness direction of said plate-like body; and
said air passage portion has a light scattering structure having a function of scattering light.

15. An optical component according to claim 14, wherein:
said air passage portion is formed as a passage hole that extends through said plate-like body in the thickness direction thereof; and
said light scattering structure includes a construction in which a hole axis direction of said air hole in said plate-like body changes in a plurality of phases.

16. An optical component according to claim 15, wherein said air hole in said plate-like body extends through said plate-like body while winding in a zigzag manner.

17. An optical component according to claims 14, wherein said plate-like body is made of any one of a polycarbonate resin, a polystyrene resin, an olefin resin, and an acrylic resin.

18. An optical component according to claims 14, wherein said plate-like body is made of a resin that includes an acrylic resin mixed with any one of a polycarbonate resin, a polystyrene resin and an olefin resin.

19. An optical component according to claims 14, wherein said plate-like body is made of a material that includes a light-transparent resin mixed with a light-transparent inorganic material.

20. An optical component according to claims 14, wherein said plate-like body is made of a flexible foam.

21. An optical component according to claims 14, wherein said plate-like body is formed of a sheet that includes woven fiber.

22. An optical component according to claims 14, wherein said plate-like body is formed of a sheet that includes a plurality of spherical resin particles strung together like beads.

23. An optical component according to claims 14, wherein said plate-like body is formed of a laminate sheet that includes a plurality of thin films having a plurality of pores.

24. A lighting device for a display device comprising:
an optical component according to claims 14; and
a light source arranged to illuminate one main surface of said optical component.

25. A display device comprising a lighting device for a display device according to claim 24, and a light controlling member arranged to control transmission of light that is emitted from said light source and is transmitted through said optical component.

26. A display device according to claim 25, wherein said light controlling member is formed of a liquid crystal panel.
